(19) United States
(12) Patent Application Publication
(10) Pub. No.: US 2015/0108145 A1
(43) Pub. Date: Apr. 23, 2015

(54) DRY FIBER WRAPPED PRESSURE VESSEL

(71) Applicants: Francesco Nettis, London (GB); Brian E. Spencer, Sacramento, CA (US); Zachary B. Spencer, Sacramento, CA (US)

(72) Inventors: Francesco Nettis, London (GB); Brian E. Spencer, Sacramento, CA (US); Zachary B. Spencer, Sacramento, CA (US)

(21) Appl. No.: 14/362,587

(22) PCT Filed: Dec. 5, 2011
(86) PCT No.: PCT/EP2011/071807

§ 371 Date: Jun. 3, 2014

(51) Int. Cl. F17C 1/06

(52) U.S. Cl. CPC F17C 1/06; F17C 2201/0128; F17C 2203/0631
USPC 220/589

(57) ABSTRACT

This invention is directed to pressure vessels in which the strength necessary to withstand the pressure exerted by a contained fluid under intended operating pressures is provided by a dry filamentous over-wrap.

### FIELD

This invention relates to a pressure vessel dry wrapped with a filamentous material that provides the vessel with the strength to withstand the pressure exerted by a compressed fluid contained in the vessel.

### BACKGROUND

The detrimental effects of the burning of fossil fuels on the environment are becoming more and more of a concern and have spurred great interest in alternative energy sources. While progress is being made with solar, wind, nuclear, geothermal, and other energy sources, it is quite clear that the widespread availability of economical rugby alternate energy sources, in particular for high energy use applications, remains an elusive target. In the meantime, fossil fuels are forecast to dominate the energy market for the foreseeable future. Among the fossil fuels, natural gas is the cleanest burning and therefore the clear choice for energy production. There is, therefore, a movement afoot to supplement or supplant, as much as possible, other fossil fuels such as coal and petroleum with natural gas as the world becomes more conscious of the environmental repercussions of burning fossil fuels. Unfortunately, much of world's natural gas deposits exist in remote, difficult to access regions of the planet. Terrain and geopolitical factors render it extremely difficult to reliably and economically extract the natural gas from these regions. The use of pipelines and overland transport has been evaluated, in some instances attempted, and found to be less than optimal in terms of economics and reliability. Interestingly, a large portion of the earth's remote natural gas reserves is located in relatively close proximity to the oceans and other bodies of water having ready access to the oceans. Thus, marine transport of natural gas from the remote locations would appear to be an obvious solution. The problem with marine transport of natural gas lies largely in the economics. Ocean-going vessels can carry just so much laden weight and the cost of shipping by sea reflects this fact, the cost being calculated on the total weight being shipped, that is, the weight of the product plus the weight of the container vessel in which the product is being shipped. If the net weight of the product is low compared to the tare weight of the shipping container, the cost of shipping per unit mass of product becomes prohibitive. This is particularly true of the transport of compressed fluids, which conventionally are transported in steel cylinders that are extremely heavy compared to weight of contained fluid. This problem has been ameliorated somewhat by the advent of Type III and Type IV pressure vessels. Type III pressure vessels are comprised of a relatively thin metal liner that is wound with a filamentous composite wrap, which results in a vessel with the strength of a steel vessel at a substantial saving in overall vessel weight. Type IV pressure vessels comprise a polymeric liner that is likewise wrapped with a composite filamentous material. Type IV pressure vessels are the lightest of all the presently approved pressure vessels. The use of Type III and Type IV vessels coupled with the trend to make these vessels very large—cylindrical vessels 18 meters in length and 2.5-3.0 meters in diameter are currently being fabricated and vessel 30 or more meters in length and 6 or more meters in diameter are contemplated—has resulted in a major step forward in optimizing the economics of ocean transport of compressed fluids.

What is needed are lighter pressure vessels, in particular lighter pressure vessels of the composite-wrapped types, that is, current Type II, Type III and Type IV vessels as well as any types of vessels developed in the future that use composite wraps to instill on the vessel the strength necessary to withstand the pressure of compressed fluids. The instant invention provides such a lighter pressure vessel.

### SUMMARY

Thus, in one aspect the present invention relates to a pressure vessel comprising a dry filamentous material disposed over a surface of the vessel.

In an aspect of this invention, the vessel has a spherical, an oblate spheroidal or toroidal shape.

In an aspect of this invention, the vessel is fabricated of a metal, ceramic or composite of insufficient strength to withstand an intended pressure exerted by a compressed fluid contained in the vessel.

In an aspect of this invention, the dry filamentous material is disposed over the entire surface of the pressure vessel.

In an aspect of this invention, a the vessel comprises a cylindrical center section and one or two dome-shaped end sections.

In an aspect of this invention, the cylindrical center section is fabricated of metal of insufficient strength to withstand an intended pressure exerted by a compressed fluid contained in the vessel and the dome-shaped end sections are fabricated of metal or composite that is of sufficient strength to withstand the intended pressure exerted by the compressed fluid.

In an aspect of this invention, the dry filamentous material is hoop-wrapped over the cylindrical center section only.

In an aspect of this invention, the cylindrical center section is fabricated of a metal of insufficient strength to withstand an intended pressure exerted by a compressed fluid contained in the vessel and the dome-shaped end sections are fabricated of metal or composite that is likewise of insufficient strength to withstand an intended pressure exerted by a compressed fluid contained in the vessel.

In an aspect of this invention, the dry filamentous material is hoop-wrapped over the cylindrical center section or hoop-wrapped and isotensoidally-wrapped over the cylindrical center section and isotensoidally-wrapped over the domed end sections.

In an aspect of this invention, the cylindrical center section and the domed end sections are fabricated of a composite of insufficient strength to withstand an intended pressure exerted by a compressed fluid contained in the vessel.

In an aspect of this invention, the dry filamentous material is hoop-wrapped over the cylindrical center section or hoop-wrapped and isotensoidally-wrapped over the cylindrical center section and isotensoidally-wrapped over the domed end sections.

In an aspect of this invention, the dry filamentous material is selected from the group consisting of glass filament, carbon filament, aramid filament and high density polyethylene filament.

In an aspect of this invention, the dry filamentous material disposed on the vessel is covered with a protective layer.

In an aspect of this invention, the protective layer comprises a polymer that does not appreciably penetrate into or impregnate the dry fibrous material.

In an aspect of this invention, the polymer is selected from the group consisting of a dicyclopentadiene polymer, a polyurethane urea polymer and a epoxy polymer.

In an aspect of this invention, the polymer is disposed over the dry filamentous material to a thickness of 2 mm to 6 mm.

In an aspect of this invention, the protective layer is selected from the group consisting of plastic tape, cloth tape and metal tape. In an aspect of this invention, the protective layer comprises a sheet of thin metal.

### BRIEF DESCRIPTION OF THE FIGURES

These figures are provided for illustrative purposes only and are not intended nor should they be construed as limiting this invention in any manner whatsoever.

FIG. 1 shows isometric projections of various types of pressure vessels.

FIG. 1A shows a spherical pressure vessel.

FIG. 1B shows and oblate spheroid, sometimes referred to as a “near sphere,” pressure vessel.

FIG. 1C shows a toroidal pressure vessel

FIG. 1D shows a pressure vessel with a cylindrical center section and one domed end section

FIG. 1E shows a pressure vessel with a cylindrical center section and two domed end sections.

FIG. 2 is a schematic representation of a cylindrical pressure vessel liner.

### DETAILED DESCRIPTION

### Discussion

It is understood that, with regard to this description and the appended claims, reference to any aspect of this invention made in the singular includes the plural and vice versa unless it is expressly stated or unambiguously clear from the context that such is not intended. For instance, a reference to a “dome” is to be construed as referring to one dome or two domes and reference to “domes” is to be construed as referring to one dome as well as two domes.

As used herein, any term of approximation such as, without limitation, near, about, approximately, substantially, essentially, appreciably and the like, mean that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the word or phrase unmodified by the term of approximation. In general, but with the preceding discussion in mind, a numerical value herein that is modified by a word of approximation may vary from the stated value by ±10%, unless expressly stated otherwise.

In particular, the term “appreciably,” when used to describe the penetration or impregnation of a dry filamentous material wrap of this invention by a polymeric protective layer, refers to the fact that, although the polymer of the polymeric protective layer may to a very slight extent penetrate into the surface of the dry filamentous material over-wrap of this invention, such penetration is insufficient to, in any detectable manner, alter the physical properties of the dry filamentous over-wrap or to transform the dry filamentous over-wrap into a composite over-wrap.

As used herein, the use of “preferred,” “preferably,” or “more preferred,” and the like refers to preferences as they existed at the time of filing of this patent application.

As used herein, a “fluid” refers to a gas, a liquid or a mixture of gas and liquid. For example, without limitation, natural gas as it is extracted from the ground and transported to a processing center is often a mixture of the gas with liquid contaminants. Such mixture would constitute a fluid for the purposes of this invention.

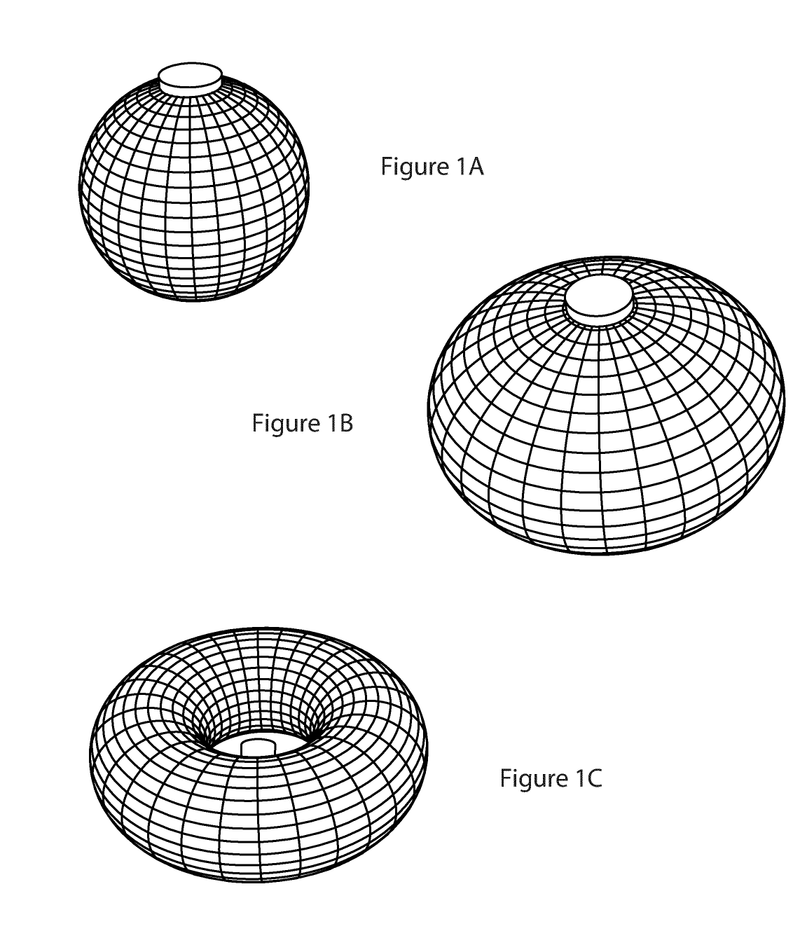

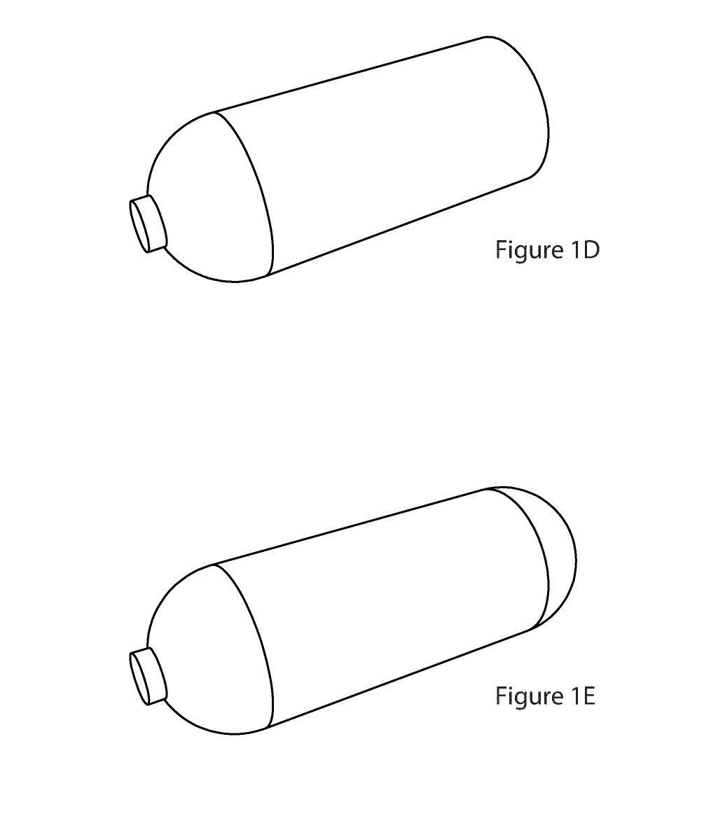

As used herein, a “wrap” or “over-wrap” refers to the winding of a filamentous material around a construct, which may be, without limitation, cylindrical, geodesic, toroidal, spherical, oblate spheroidal, etc. as illustrated in FIG. 1. The filamentous material is wound around the construct in a dry state, that is, as a dry filamentous material.

As used herein, a “polymeric composite” has the meaning that would be ascribed to it by those skilled in the art. In brief, it refers to a fibrous or filamentous material that is impregnated with, enveloped by or both impregnated with and enveloped by a polymer matrix material.

Pressure vessels for the transport of compressed fluids, such as compressed natural gas, CNG, presently constitute four regulatory agency approved classes, all of which are cylindrical with one or two domed ends:

Class I. Consists of an all metal, usually aluminum or steel, construct. This type of vessel is inexpensive but is very heavy in relation to the other classes of vessels. The entire vessel is of sufficient strength to withstand the intended pressure exerted on the vessel by a contained compressed fluid and therefore does not require any manner of strength-enhancing over-wrap, including the dry filamentous over-wrap of this invention. Type I pressure vessels currently comprise a large portion of the containers used to ship compressed fluids by sea, their use in marine transport incurs very tight economic constraints.

Class II. Consists of a thinner metal cylindrical center section with standard thickness metal end domes such that only the cylindrical portion need be reinforced, currently with a composite over-wrap. The composite wrap generally constitutes glass or carbon filament impregnated with a polymer matrix. The composite is usually “hoop wrapped” around the middle of the vessel. The domes at one or both ends of the vessel are of sufficient strength to withstand the pressures developed in the vessel under normal use and are not composite wrapped. In Class II pressure vessels, the metal liner carries about 50% of the stress and the composite carries about 50% of the stress resulting from the internal pressure of the contained compressed fluid. Class II vessels are lighter than Class I vessels but tend to be more expensive.

Class III. Consists of a thin metal liner that comprises the entire structure, that is, the cylindrical center section and the end dome(s). Thus, the liner is currently reinforced with a filamentous composite wrap around entire vessel. The stress in Type III vessels is shifted virtually entirely to the filamentous material of the composite wrap; the liner need only withstand a small portion of the stress. Type III vessels are much lighter than type I or II vessels but, again, tend to be generally more expensive than Type I and Type II vessels.

Class IV. Consists of a polymeric, essentially gas-tight liner that comprises both the cylindrical center section and the dome(s), all of which is currently fully wrapped with a filamentous composite. The composite wrap provides the entire strength of the vessel. Type IV vessels are by far the lightest of the four approved classes of pressure vessels.

As noted above, Type II, Ill and IV pressure vessel currently require a composite over-wrap on a vessel liner to give them the necessary strength to withstand the intended pressure exerted by a compressed fluid contained in the vessel. It is known, however, that the polymeric matrix of the composite wrap adds little or no strength to the overwrap. Thus, this invention is related to a dry filamentous material that is disposed over a pressure vessel liner in a dry state and that remains in essentially a dry state for the life-time of the pressure vessel. “Essentially” in a dry state takes into consideration that, in use, particularly for marine transport of compressed fluids, the filamentous material may inadvertently become dampened by environmental moisture and the like. That is, the dry filamentous material is intended to be disposed over the vessel dry and to be dry when the vessel is first put in use.

As used herein, “intended pressure” refers to the pressure that a vessel is designed and constructed to withstand under normal operating conditions according to the standards set forth by such organizations as, without limitation, the American Society of Mechanical Engineers (ASME), Det Norske Veritas (DNV), American Business Standards (ABS) and the International Organization for Standardization (ISO). These organizations establish stress levels that the materials of a pressure vessel must be able to withstand under normal operating conditions with added safety factors. For example, without limitation, the ASME sets a standard that includes a safety factor of 5 with regard to the stresses a pressure vessel must be capable of withstanding over and above the vessel's normal operating pressure. These safety factors may vary from one standards-setting organization to another. For instance, the DNV, depending on the material of which a pressure vessel is fabricated, requires a safety factor of 3.5 and upward.

The pattern and manner of disposing a dry filamentous material onto a pressure vessel is the same as that for disposing a composite material onto a vessel. That is, for a Type II pressure vessel, the over-wrap is wound over the vessel liner in a relatively straight-forward manner referred by those skilled in the art as “hoop-wrapping,” which is described elsewhere herein. On the other hand, for Type III and Type IV pressure vessels, to produce a vessel that has the requisite strength to withstand the intended pressure exerted by a contained compressed fluid, it is necessary to wrap the vessel, sometimes in addition to hoop-wrapping, sometimes in lieu of hoop-wrapping, in a manner called “isostensoidal-wrapping,” which is likewise known in the art and is described in more detail elsewhere herein. When an entire vessel is wrapped with a dry filamentous material of this invention, the underlying metal or polymeric structure is conventionally referred to as a “liner,” as was done above in the description of the various types of pressure vessels. The liner provides the surface on which the dry filamentous material is wound and is the surface with which the contained compressed fluid is in direct contact.

For the purpose of this disclosure, only a pressure vessel liner that forms a cylindrical center section with a domed end section (for the sake of brevity, such a vessel will henceforth be referred to simply as a “cylindrical pressure vessel”) is described in detail. The dry filamentous material wrap of this invention would, however, be equally applicable to a spherical, oblate spheroid (near-sphere) or toroidal pressure vessel.

Once the cylindrical pressure vessel liner is in hand, while it is hardly a trivial exercise, it is a well-established procedure to design and apply to the liner, including the end domes, a dry filamentous material, the end result being a completely dry filamentous material-wrapped pressure vessel. In brief, for a given diameter cylindrical section of a pressure vessel liner, a given dome shape , a given dome polar opening diameter and a given filamentous material width, a winding pattern can readily be determined using known algorithms including, without limitation, netting analysis, finite element analysis and combinations thereof. Using these mathematical formulae permits the design of a winding pattern that results is an isotensoid wrap of the vessel. The term “isotensoid” refers to the property of the fully-wound vessel in which each filament of the wrap experiences a constant pressure at all points in its path. This is currently considered to be the optimal design for a filament-wrapped pressure vessel because, in this configuration, virtually the entire stress imposed on the vessel by a compressed fluid is assumed by the isotensoidally-disposed filaments.

Dome shapes may vary and include, but are not limited to, 2:1 ellipsoidal, 3:1 ellipsoidal and geodesic. The characteristics “2:1” and “3:1” refer to the ratio of the major axis to the minor axis of an ellipse. Presently preferred is a geodesic dome shape since it constitutes a surface of revolution that is amenable to numerical solution for each polar opening diameter, each cylindrical section diameter and each filament width. This numerical solution in turn permits the progressive plotting of the curvature of the dome from the diameter of the pressure vessel toward the polar opening. Knowledge of the curvature then permits the design and application of a maximum strength, i.e., isotensoid, filament wrap to the vessel using the algorithms mentioned above. Such pressure vessels exhibit the optimal combination of highest pressure loading at the lightest overall weight.

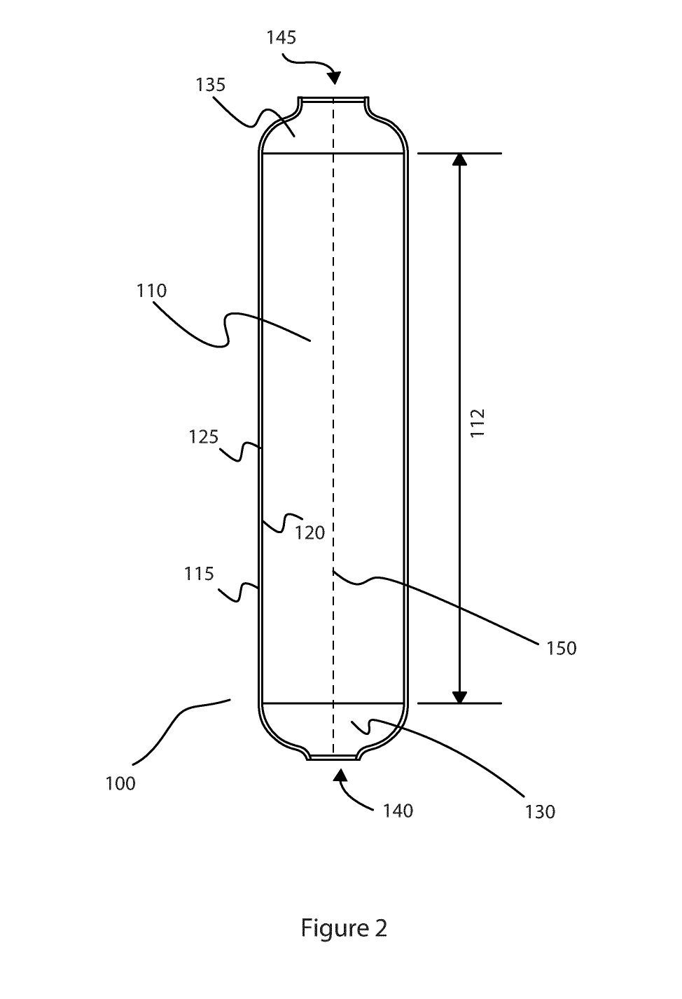

A schematic representation of a cylindrical pressure vessel liner is shown in FIG. 2. Pressure vessel liner 100 is comprised of cylindrical portion 112, domes 130 and 135 and polar openings 140 and 145 in domes 130 and 135. It is noted that it is not necessary that both domes 130 and 135 contain polar openings nor is it necessary that, if both do have polar openings, that they are of the same size. A “polar opening” refers to a hole in the dome, usually circular in shape, the perimeter of which is radially equidistant from centerline 150 of vessel liner 100, as shown in FIG. 2. A boss, which may be metal or composite, is fitted to the polar opening or openings, the liner is wound with a dry filamentous material and then additional hardware, well-known to those in the art, can be coupled to the boss, for the delivery and removal of fluids from the vessel.

It is noted that, in this disclosure, no actual thicknesses or amounts of filamentous dry material wrapping are expressly set forth. This is so because the thicknesses of the various sections of a pressure vessel and the amount of wrapping are dependent on the intended operating pressure of the vessel. The pressures are, of course, predetermined and exceeding them could result in catastrophic failure of the pressure vessel. Once the maximum operating pressure of a vessel is established and the physical properties of the materials being used to fabricate the vessel, be they metal, polymer, ceramic, composite or other, are defined, it is a straight-forward application of engineering principles to determine the requisite thickness and amount of dry filamentous material over-wrap. Since maximum operating pressures can vary substantially, it is unnecessary to expressly set forth any such specific dimensions for the purposes of this invention.

In general, any filamentous material may be used to create the dru filmanetoud material over-wrap of this invention. Such materials include, without limitation, natural (silk, hemp, flax, etc.), metal, ceramic, basalt and synthetic polymer fibers and filaments. Presently preferred materials include glass fibers, commonly known as fiberglass, carbon fibers, aramid fibers, which go mostly notably under the trade name Kevlar® and ultra-high molecular weight polyethylene, such as Spectra® (Honeywell Corporation) and Dyneeva® (Royal DSM N.V.). The filamentous material may comprise, for example without limitation, single strands of material, multiple individual threads, which may remain as a bundle of separate threads or may be woven together into multi-thread strands, or it may be a filamentous tape, i.e. a construct having a cross-section with a width that is greater than its thickness.

Once the filamentous material has been disposed, that is, wound, onto the portions of the pressure vessel requiring such, the vessel may be considered complete with regard to the basic strength-providing elements of the vessel and may be put into use as such. The operating environments that pressure vessels are generally subjected, however, often militates in favor of a protective layer disposed over the filamentous windings. Such a protective layer is within the scope of this invention and may comprise, without limitation, plastic tape, cloth tape or metal tape wound over and contiguous to the filamentous material winding. The protective coating may also comprise a thin sheet of metal or polymer that is disposed in sheets over the filamentous windings. In yet another embodiment, the protective layer may comprise a polymer that is disposed over the filamentous windings as a formulation which will not appreciably penetrate into or impregnate the filamentous material as described previously herein. Such polymer formulation include, without limitation, epoxy polymer formulations, polyester polymers formulations, polyimide polymer formulations, polyurethane urea formulations and dicyclopentadiene polymer formulations. In some embodiments, the polymer formulation comprises prepolymers, i.e., monomers or oligomers wherein the prepolymer formulation has properties, such as high viscosity, that prevents the prepolymer formulation from penetrating into or impregnating the filamentous material windings prior to curing.

A pressure vessel comprising a dry filamentous material over-wrap that provides strength to the vessel as set forth herein can be used to contain and transport any type of fluid that is amenable to such transport and so long as the vessel liner, be it metal, ceramic or polymer, is selected so as to be impermeable and impervious to the contained compressed fluid. A presently preferred use of a pressure vessel of this invention is for the containment and transport of natural gas, often referred to as “compressed natural gas” or simply “CNG.”

CNG may be contained and transported in the vessels of this invention both as a purified gas and as “raw gas.” Raw gas refers to natural gas as it comes, unprocessed, directly from the well. It contains, of course, the natural gas (methane) itself but also may contain liquids such as condensate, natural gasoline and liquefied petroleum gas. Water may also be present as may other gases, either in the gaseous state or dissolved in the water, such as nitrogen, carbon dioxide and hydrogen sulfide. Some of these may be reactive in their own right or may be reactive when dissolved in water, such as carbon dioxide and hydrogen sulfide which produce an acid when dissolved in water. The presently preferred liner polymer, a dicyclopentadiene polymer, has excellent properties with regard to chemical resistance to the above, and other materials that might constitute raw gas. High density polyethylene also works well with raw gas. Other liner materials that are impervious to raw gas components will readily be discernable based on the disclosures herein and pressure vessels having composite bosses of this invention together with any type of vessel or vessel liner composition are within the scope of this invention.

1. A pressure vessel comprising a dry filamentous material disposed over a surface of the vessel.

2. The pressure vessel of claim 1, wherein the vessel has a spherical, an oblate spheroidal or toroidal shape.

3. The pressure vessel of claim 2, wherein the vessel is fabricated of a metal, ceramic or composite of insufficient strength to withstand an intended pressure exerted by a compressed fluid contained in the vessel.

4. The pressure vessel of claim 3, wherein the dry filamentous material is disposed over the entire surface of the pressure vessel.

5. The pressure vessel of claim 1, wherein the vessel comprises a cylindrical center section and one or two dome-shaped end sections.

6. The pressure vessel of claim 5, wherein the cylindrical center section is fabricated of metal of insufficient strength to withstand an intended pressure exerted by a compressed fluid contained in the vessel and the dome-shaped end sections are fabricated of metal or composite that is of sufficient strength to withstand the intended pressure exerted by the compressed fluid.

7. The pressure vessel of claim 6, wherein the dry filamentous material is hoop-wrapped over the cylindrical center section only.

8. The pressure vessel of claim 5, wherein the cylindrical center section is fabricated of a metal of insufficient strength to withstand an intended pressure exerted by a compressed fluid contained in the vessel and the dome-shaped end sections are fabricated of metal or composite that is likewise of insufficient strength to withstand an intended pressure exerted by a compressed fluid contained in the vessel.

9. The pressure vessel of claim 8, wherein the dry filamentous material is hoop-wrapped over the cylindrical center section or hoop-wrapped and isotensoidally-wrapped over the cylindrical center section and isotensoidally-wrapped over the domed end sections.

10. The pressure vessel of claim 5, wherein the cylindrical center section and the domed end sections are fabricated of a composite of insufficient strength to withstand an intended pressure exerted by a compressed fluid contained in the vessel.

11. The pressure vessel of claim 10, wherein the dry filamentous material is hoop-wrapped over the cylindrical center section or hoop-wrapped and isotensoidally-wrapped over the cylindrical center section and isotensoidally-wrapped over the domed end sections.

12. The pressure vessel of claim 1, wherein the dry filamentous material is selected from the group consisting of glass filament, carbon filament, aramid filament and high density polyethylene filament.

13. The pressure vessel of claim 1, wherein the dry filamentous material disposed on the vessel is covered with a protective layer.

14. The pressure vessel of claim 13, wherein the protective layer comprises a polymer that does not appreciably penetrate into or impregnate the dry fibrous material.

15. The pressure vessel of claim 14, wherein the polymer is selected from the group consisting of a dicyclopentadiene polymer, a polyurethane urea polymer and a epoxy polymer.

16. The pressure vessel of claim 15, wherein the polymer is disposed over the dry filamentous material to a thickness of 2 mm to 6 mm.

17. The pressure vessel of claim 13, wherein the protective layer is selected from the group consisting of plastic tape, cloth tape and metal tape.

18. The pressure vessel of claim 13, wherein the protective layer comprises a sheet of thin metal.
